(19) United States
(12) Patent Application Publication
(10) Pub. No.: US 2018/0227874 A1
(43) Pub. Date: Aug. 9, 2018

(54) APPARATUS, SYSTEM AND METHOD OF PROVIDING WLAN MEASUREMENT INFORMATION FROM A CELLULAR NODE TO A LOCATION SERVER

(71) Applicant: INTEL IP CORPORATION, Santa Clara, CA (US)

(72) Inventor: Alexander SIROTKIN, Giv'on Hachadasha (IL)

(21) Appl. No.: 15/748,342

(22) PCT Filed: Dec. 24, 2015
(86) PCT No.: PCT/US2015/000336

§ 371 Date: Jan. 29, 2018

Related U.S. Application Data
(60) Provisional application No. 62/198,878, filed on Jul. 30, 2015.

(51) Int. Cl. H04W 64/00; G01S 11/06; G01S 13/76

(52) U.S. Cl. CPC H04W 64/00; H04W 84/12; G01S 13/765; G01S 11/06

(57) ABSTRACT

Some demonstrative embodiments include devices, systems and methods of providing WLAN measurement information from a cellular node to a location server. For example, an apparatus of an eNB may include a network interface configured to receive a request message, the request message including a request from a location server for WLAN measurements corresponding to a UE; and a location processing component configured to trigger the eNB to send a measurement request to at least one measurement provider selected from the group consisting of the UE and at least one WLAN AP, the location processing component configured to receive from the at least one measurement provider WLAN measurement information, which is based at least on a range between the UE and the WLAN AP, the location processing component configured to trigger the eNB to send to the location server a response message including the WLAN measurement information.

### CROSS REFERENCE

This Application claims the benefit of and priority from U.S. Provisional Patent Application No. 62/198,878 entitled “LPPA AND SLMAP PROTOCOL ENHANCEMENTS FOR WLAN BASED POSITIONING”, filed Jul. 30, 2015, the entire disclosure of which is incorporated herein by reference.

### TECHNICAL FIELD

Some embodiments described herein generally relate to providing Wireless Local Area Network (WLAN) measurement information from a cellular node to a location server.

### BACKGROUND

Positioning mechanisms may be configured to enable determining a geographical location of a mobile device, for example, by determining geographical coordinates of the mobile device and mapping the geographical coordinates to a location, and/or by determining range information between the mobile device and one or more other devices and/or locations.

The information regarding the location of the mobile device may be used, for example, in support of Radio Resource Management functions, and/or location-based services for operators, subscribers, and/or third-party service providers.

Various applications and/or services use range information between devices. The range information may enable, for example, users of the devices to meet new people and/or to use one or more services provided by the devices, e.g., when the devices are in proximity to each other. The range information may enable, for example, one or more advertisers of services to interact with potential clients of the services, e.g., based on the range information.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic illustration of a Fine Time Measurement (FTM) procedure, in accordance with some demonstrative embodiments.

FIG. 3 is a schematic flow-chart illustration of a method of providing Wireless Local Area Network (WLAN) measurement information from a cellular node to a location server, in accordance with some demonstrative embodiments.

FIG. 4 is a schematic flow-chart illustration of a method of processing WLAN measurement information at a location server, in accordance with some demonstrative embodiments.

FIG. 5 is a schematic illustration of a product, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment,” “an embodiment,” “demonstrative embodiment,” “various embodiments,” etc., indicate that the embodiment(s) so described may include a particular feature, structure, or characteristic, but not every embodiment necessarily includes the particular feature, structure, or characteristic Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a Smartphone device, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wireless node, a; cellular node, a relay node, a base station (BS), a wired or wireless router, a wired or wireless modem, a video device, an audio device, an audio-video (A/V) device, a wired or wireless network, a wireless area network, a cellular network, a cellular node, a cellular device, a Wireless Local Area Network (WLAN), a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, vending machines, sell terminals, and the like.

Some embodiments may be used in conjunction with devices and/or networks operating in accordance with existing Long Term Evolution (LTE) specifications (including 3GPP TS 36.300 (“TS 36.300 Evolved Universal Terrestrial Radio Access (E-UTRA) and Evolved Universal Terrestrial Radio Access Network (E-UTRAN); Overall description; Stage 2, version 11.7.0 Release 11”, September 2013); 3GPP TS 36.331 (ETSI TS 136 331; V12.3.0 (2014 September); LTE; Evolved Universal Terrestrial, Radio Access (E-UTRA); Radio Resource Control (RRC); Protocol specification (3GPP TS 36.331 version 12.3.0 Release 12); 3GPP TS 36.455 (“ETSI TS 136 455 V12.2.0 (2015 April); LTE; Evolved Universal Terrestrial Radio Access (E-UTRA); LTE Positioning Protocol A (LPPa); (3GPP TS 36.455 version 12.2.0 Release 12)”); and/or 3GPP TS 36.459 (ETSI TS 136 459 V12.1.0 (2015 April ); LTE; Evolved Universal Terrestrial Radio Access Network (E-UTRAN); SLm interface Application Protocol (SlmAP) (3GPP TS 36.459 version 12.1.0 Release 12))), and/or future versions and/or derivatives thereof, devices and/or networks operating in accordance with existing IEEE 802.16 standards (IEEE-Std 802.16, 2009 Edition, Air Interface for Fixed Broadband Wireless Access Systems; IEEE-Std 802.16e, 2005 Edition, Physical and Medium Access Control Layers for Combined Fixed and Mobile Operation in Licensed Bands; amendment to IEEE Std 802.16-2009, developed by Task Group m) and/or future versions and/or derivatives thereof, devices and/or networks operating in accordance with existing IEEE 802.11 standards (IEEE 802.11-2012, IEEE Standard for Information technology—Telecommunications and information exchange between systems. Local and metropolitan area networks—Specific requirements Part 11: Wireless LAN Medium Access Control (MAC) and Physical Layer (PHY) Specifications, Mar. 29, 2012) and/or future versions and/or derivatives thereof, units and/or devices which are part of the above networks, and the like.

Some embodiments may be used in conjunction with one or more types of wireless communication signals and/or systems, for example, Radio Frequency (RF), Frequency-Division Multiplexing (FDM), Orthogonal FDM (OFDM), Single Carrier Frequency Division Multiple Access (SC-FDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wireless Fidelity (Wi-Fi), Wi-Max, ZigBee™, Ultra-Wideband (UWB), Global System for Mobile communication (GSM), second generation (2G), 2.5G, 3G, 3.5G, 4G, 4.5G, Fifth Generation (5G) mobile networks, 3GPP, Long Term Evolution (LTE) cellular system, LTE advance cellular system, LTE Unlicensed systems, High-Speed Downlink Packet Access (HSDPA), High-Speed Uplink Packet Access (HSUPA), High-Speed Packet Access (HSPA), HSPA+, Single Carrier Radio Transmission Technology (1×RTT), Evolution-Data Optimized (EV-DO), Enhanced Data rates for GSM Evolution (EDGE), and the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit. The verb “communicating” may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a dipole antenna, a set of switched beam antennas, and/or the like.

The term “cell”, as used herein, may include a combination of network resources, for example, downlink and optionally uplink resources. The resources may be controlled and/or allocated, for example, by a node (also referred to as a “base station”), or the like. The linking between a carrier frequency of the downlink resources and a carrier frequency of the uplink resources may be indicated in system information transmitted on the downlink resources.

Some demonstrative embodiments are described herein with respect to a LTE network. However, other embodiments may be implemented in any other suitable cellular network or system, e.g., a Universal Mobile Telecommunications System (UMTS) cellular system, a GSM network, a 3G cellular network, a 4G cellular network, a 4.5G network, a 5G cellular network, a WiMAX cellular network, and the like.

Some demonstrative embodiments are described herein with respect to a WLAN system, a WiFi system, and/or a WiGig system. However, other embodiments may be implemented in any other suitable non-cellular network.

Some demonstrative embodiments are described herein with respect to a WLAN Access Point (AP). However, other embodiments may be implemented with respect to any other WLAN access device, WLAN Termination (WT) Node, WLAN controller, and/or WLAN access manager node and/or interface.

Some demonstrative embodiments are described herein with respect to a WLAN AP operating as a raging and/or positioning responder. However, other embodiments may be implemented with respect to any other device capable of operating as and/or performing the functionality of a ranging and/or positioning responder.

Some demonstrative embodiments are described herein with respect to one or more Fine Time Measurement (FTM) operations and/or communications, for example according to an FTM procedure and/or protocol. However, other embodiments may implement any other additional or alternative positioning measurements and/or communications, ranging measurements and/or communications, proximity measurements and/or communications, location estimation measurements and/or communications, and/or Time of Flight (ToF) measurements and/or communications, for example, according to a Received Signal Strength Indication (RSSI), e.g., as described below, and/or any other additional or alternative procedure and/or protocol.

Some demonstrative embodiments may be used in conjunction with a Heterogeneous Network (HetNet), which may utilize a deployment of a mix of technologies, frequencies, cell sizes and/or network architectures, e.g., including cellular, millimeter wave (“mmWave” or “mmW”), and/or the like. In one example, the HetNet may include a radio access network having layers of different-sized cells ranging from large macrocells to small cells, for example, picocells and femtocells. Other embodiments may be used in conjunction with any other suitable wireless communication network.

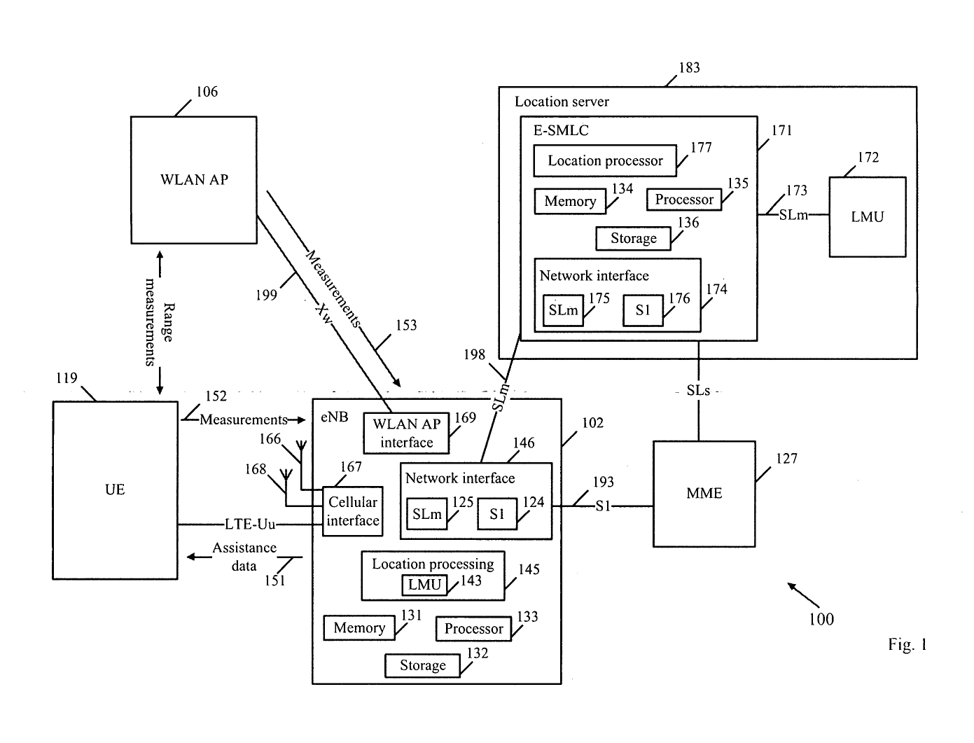

Reference is now made to FIG. 1, which schematically illustrates a block diagram of a system 100, in accordance with some demonstrative embodiments. In one example, cellular system 100 may include a 4^{th} generation cellular system such as, for example, a long-term evolution (LTE) or LTE advance cellular system, and the like, or a 5G cellular system. In other embodiments, system 100 may include any other cellular system.

As shown in FIG. 1, in some demonstrative embodiments, system 100 may include one or more nodes, e.g., including a node 102, capable of communicating content, data, information and/or signals with one or more User Equipment (UE) 119, e.g., as described below.

In some demonstrative embodiments, node 102 may be configured to include, operate as, and/or perform the functionality of, an Evolved Node B (eNB) and/or to provide one or more functionalities of an eNB, e.g., to one or more UE 119, which may be connected to node 102. For example, node 102 may be configured to perform radio resource management (RRM), radio bearer control, radio admission control (access control), connection mobility management, resource scheduling between UEs and eNB radios, e.g., Dynamic allocation of resources to UEs in both uplink and downlink, header compression, link encryption of user data streams, packet routing of user data towards a destination, e.g., another eNB or an Evolved Packet Core (EPC), scheduling and/or transmitting paging messages, e.g., incoming calls and/or connection requests, broadcast information coordination, measurement reporting, and/or any other operations.

In other embodiments, node 102 may perform any other additional or alternative functionality and/or operations, and/or may operate as, and/or perform the functionality of, any other cellular node, network controller, base station or any other node or network device.

In some demonstrative embodiments, UE 119 may include, for example, a Mobile Device (MD), a Station (STA), a mobile computer, a laptop computer, a notebook computer, a tablet computer, an Ultrabook™ computer, an Internet of Things (IoT) device, a wearable device, a sensor device, a mobile internet device, a handheld computer, a handheld device, a storage device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a mobile phone, a cellular telephone, a PCS device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a video device, an audio device, an A/V device, a gaming device, a media player, a Smartphone, or the like.

In some demonstrative embodiments, system 100 may include one or more WLAN APs 106, which may be configured to perform with UE 119, and/or to communicate signals allowing UE 119 to perform, one or more positioning operations, ranging operations, ToF operations, FTM operations, RSSI measurements, communications and/or procedures, e.g., as described below.

In some demonstrative embodiments, the one or more WLAN APs 106 may include one or more WLAN APs, one or more FTM responders, one or more dedicated responder stations, one or more non-dedicated responder stations, one or more stations having at least capabilities of an FTM responder, one or more stationary devices having a known geo-location, one or more mobile devices, one or more UEs, one or more routers, and/or any other device and/or station capable of performing with UE 119, and/or communicate signals allowing UE 119 to perform, one or more positioning operations, ranging operations, ToF operations, FTM operations, RSSI measurements, communications and/or procedures, e.g., as described below.

In some demonstrative embodiments, UE 119, node 102 and/or WLAN AP 106 may include one or more communication interfaces to perform communication between UE 119, node 102, WLAN AP 106 and/or with one or more other wireless communication devices, e.g., as described below.

Some demonstrative embodiments include an interface 199 (also referred to as “the access device interface”, “the horizontal interface”, “the “Xw interface”, “the X2-W interface” or “the cellular/WLAN interface”), which may include circuitry and/or logic configured to interface, e.g., directly or indirectly, between a cellular network element, e.g., node 102, and a WLAN element, e.g., WLAN AP 106, as described in detail below.

In some demonstrative embodiments, interface 199 may be implemented to interface between an eNB and a WLAN node, e.g., as described below. However, in other embodiments, the cellular/WLAN interface 199 may be implemented to directly interface between any other cellular device and any other WLAN device. In one example, the cellular/WLAN interface 199 may be implemented to directly interface between an eNB and a WLAN AP or WLAN AC. In another example, the cellular/WLAN interface 199 may be implemented to directly interface between a UMTS RNC and a WT node. In another example, the cellular/WLAN interface 199 may be implemented to directly interface between a UMTS RNC and a WLAN AP or AC.

In some demonstrative embodiments, interface 199 may be utilized to enhance and/or increase the efficiency of interworking, integration and/or management of the cellular and WLAN radio access technologies.

In some demonstrative embodiments, interface 199 may be configured to perform and/or support one or more aggregation operations and/or functionalities, for example, to transfer traffic, e.g., in addition to transferring control plane information.

In some demonstrative embodiments, interface 199 may be utilized to improve efficiency of resource management, to provide efficient load balancing, and/or to improve mobility between Radio Access Technology (RAT) networks.

In some demonstrative embodiments, node 102 may include an interface (“Network interface”) 146, e.g., a vertical interface, including circuitry and/or logic configured to communicate with one or more elements of a network, for example, a Core Network (CN), e.g., an Evolved Packet Core (EPC).

In some demonstrative embodiments, network interface 146 may include an S1 vertical interface component 124 configured to communicate between node 102 and a Mobility Management Entity (MME) 127, e.g., via an S1-MME interface 193.

In some demonstrative embodiments, node 102 may include a WLAN AP interface 169 (also referred to as “WLAN control interface” or a “WT node interface”) including circuitry and/or logic configured to communicate with WLAN AP 106, e.g., as described below. In one example, interface 169 may include an AP interface, e.g., to communicate directly with an AP. In another example, interface 169 may include a WT node interface, e.g., to communicate with a WT node controlling WLAN AP 106. In another example, interface 169 may include any other non-cellular RAT interface to communicate with a node of a non-cellular RAT network.

In some demonstrative embodiments, interface 169 may be configured to communicate between node 102 and WLAN AP 106 via a direct link of interface 199. In some demonstrative embodiments, interface 199 may include a Point to Point (P2P) link. In some demonstrative embodiments, interface 199 may be implemented by any wired and/or wireless link, e.g., using any suitable, Physical Layer (PHY) components and/or protocols.

In some demonstrative embodiments, node 102 may include a cellular interface including circuitry and/or logic to communicate user plane traffic, directly or indirectly, between node 102 and UE 119.

In some demonstrative embodiments, node 102 may communicate the user plane traffic directly with UE 119, for example, if node 102 performs the functionality of an eNB. According to these embodiments, node 102 may include an air interface, for example, a cellular transceiver (TRx) 167, including circuitry and/or logic configured to communicate with UE 119 via a cellular link.

In some demonstrative embodiments, cellular TRx 167 may be configured to communicate over a cellular frequency band.

In some demonstrative embodiments, cellular TRx 167 may include one or more wireless transmitters, receivers and/or transceivers including circuitry and/or logic configured to send and/or receive wireless communication signals, RF signals, frames, blocks, transmission streams, packets, messages, data items, and/or data.

In some demonstrative embodiments, cellular TRx 167 may include circuitry, logic, modulation elements, demodulation elements, amplifiers, analog to digital and digital to analog converters, filters, and/or the like.

In some demonstrative embodiments, cellular TRx 167 may include a multiple input multiple output (MIMO) transmitters receivers system (not shown), including circuitry and/or logic configured to perform antenna beamforming methods, if desired. In other embodiments, cellular TRx 167 may include any other transmitters and/or receivers.

In some demonstrative embodiments, cellular TRx 167 may include LTE, WCDMA and/or TD-SCDMA modulator and/or demodulator circuitry (not shown) configured to modulate and/or demodulate signals to be transmitted by, and/or signals received by, node 102.

In some demonstrative embodiments, cellular TRx 167 may include a decoder, e.g., a turbo decoder, and/or an encoder, e.g., a turbo encoder, (not shown) including circuitry and/or logic for encoding and/or decoding data bits into data symbols, if desired. In some demonstrative embodiments, cellular TRx 167 may include OFDM and/or SC-FDMA modulators and/or demodulators (not shown) configured to communicate OFDM signals over downlink (DL) channels, and/or SC-FDMA signals over uplink (UL) channels.

In some demonstrative embodiments, cellular TRx 167 may include, or may be associated with, one or more antennas. In one example, cellular TRx may be associated with at least two antennas, e.g., antennas 168 and 166. In another example, cellular TRx 167 may be associated with one antenna or more than two antennas.

In some demonstrative embodiments, antennas 168 and/or 166 may include any type of antennas suitable for transmitting and/or receiving wireless communication signals, blocks, frames, transmission streams, packets, messages and/or data. For example, antennas 168 and/or 169 may include any suitable configuration, structure and/or arrangement of one or more antenna elements, components, units, assemblies and/or arrays. For example, antennas 168 and/or 169 may include a phased array antenna, a dipole antenna, a single element antenna, a set of switched beam antennas, and/or the like.

In some embodiments, antennas 168 and/or 169 may implement transmit and receive functionalities using separate transmit and receive antenna elements. In some embodiments, antennas 168 and/or 169 may implement transmit and receive functionalities using common and/or integrated transmit/receive elements.

In some demonstrative embodiments, node 102 may include a location processing component 145 configured to perform, and/or to control, trigger, cause and/or instruct node 102 to perform, one or more operations, functionalities, and/or communications to allow processing location, positioning and/or ranging information corresponding to a location of UE 119, e.g., as described below.

In some demonstrative embodiments, location processing component 145 may be configured to perform, and/or to control, trigger, cause and/or instruct node 102 to perform, one or more operations, functionalities, and/or communications to provide information corresponding to a location of UE 119 to at least one location server 183, e.g., as described below.

In some demonstrative embodiments, node 102 and/or location server 183 may be configured to support one or more positioning mechanisms, for example, including one or more indoor positioning enhancements, e.g., for UTRA, LTE and/or WLAN, for example, in accordance with a 3GPP specification, e.g., 3GPP TR 37.857 (“37.857 v0.3.0 Study on Indoor Positioning Enhancements for UTRA and LTE”, R1-152610, May 2015), and/or any other Specification, Protocol, and/or Standard.

In some demonstrative embodiments, node 102 and/or location server 183 may be configured to support one or more positioning mechanisms, for example, an FTM mechanism, a RSSI mechanism, e.g., a beacon RSSI mechanism, and/or any other positioning and/or ranging mechanism.

In some demonstrative embodiments, an RSSI measurement mechanism may include measuring, e.g., at UE 119 and/or at WLAN AP 106 one or more RSSIs corresponding to signals communicated between UE 119 and WLAN AP 106. In one example, UE 119 may measure the RSSI of one or more beacons from WLAN AP 106.

In some demonstrative embodiments, node 102 and/or location server 183 may be configured to support one or more positioning mechanisms, for example, in accordance with, and/or by enhancing, one or more protocols, for example, a LTE Positioning Protocol A (LPPa), for example, in accordance with a 3GPP TS 36.455 Specification, e.g., “ETSI TS 136 455 V12.2.0 (2015 April); LTE; Evolved Universal Terrestrial Radio Access (E-UTRA); LTE Positioning Protocol A(LPPa); (3GPP TS 36.455 version 12.2.0 Release 12)”; and/or a SLmAP protocol, e.g., in accordance with a 3GPP TS 36.459 Specification, e.g., “ETSI TS 136 459 V12.1.0 (2015 April); LTE; Evolved Universal Terrestrial Radio Access Network (E-UTRAN); SLm interface Application Protocol (SlmAP) (3GPP TS 36.459 version 12.1.0 Release 12)”.

In some demonstrative embodiments, node 102 and/or location server 183 may be configured to support network based WLAN positioning methods, for example, an FTM and/or an RSSI positioning method, e.g., as described below.

In some demonstrative embodiments, node 102 and/or location server 183 may be configured to support positioning, for example, indoor positioning, for example, based on WLAN measurements, for example, WLAN FTM measurements and/or RSSI measurements, for example, while using one or more LPPa, SlmAP, and/or RRC protocols, e.g., as described below.

In some demonstrative embodiments, location server 183 may include, operate as, and/or perform at least part of the functionality of an Evolved Serving Mobile Location Centre (E-SMLC) 171, e.g., as described below.

In some demonstrative embodiments, E-SMLC 171 may communicate with a Location Management Unit (LMU) 172, for example, via an SLm interface 173.

In some demonstrative embodiments, location server 183 may include, operate as, and/or perform at least part of the functionality of LMU 172. In other embodiments, location server 183 and LMU 172 may be implemented as to separate and/or independent elements of system 100.

In some demonstrative embodiments, E-SMLC 171 and node 102 may be configured to communicate and/or perform network based positioning, e.g., with respect to a positioning of UE 119, for example, according to an LPPa protocol. For example, the LPPa protocol may enable E-SMLC 171 and node 102 to communicate, e.g., transparently to MME 127, on SLs and/or S1 interfaces, e.g., as shown in FIG. 1. In one example, E-SMLC 171 and node 102 may implement the LPPa protocol, for example, for Enhanced Cell Identifier (ID) (E-CID) positioning, and/or for any other type of positioning.

In some demonstrative embodiments, E-SMLC 171 and node 102 may be configured to communicate and/or perform network based positioning, e.g., with respect to a positioning of UE 119, for example, according to an SLmAP protocol. For example, node 102 may include an LMU component 143, which may be configured to communicate with E-SMLC 171, for example, via SLm interface 198. In one example, E-SMLC 171 and node 102 may implement the SLmAP protocol, for example, for Uplink-Time Difference of Arrival (UTDOA) positioning, and/or for any other type of positioning.

In some demonstrative embodiments, node 102 and/or location server 183 may be configured to support an enhancement of a positioning protocol, for example, an LPPa protocol and/or a SlmAP protocol, for example, to enable communicating between node 102 and E-SMLC 171 information corresponding to a location of UE 119, e.g., as described below.

In some demonstrative embodiments, location processing component 145 may be configured to control, cause, instruct and/or trigger node 102 to request UE 119 and/or WLAN AP 106 to provide measurement information, which is based at least on a range between WLAN AP 106 and UE 119, e.g., as described below.

In some demonstrative embodiments, location processing component 145 may be configured to control, cause, instruct and/or trigger node 102 to receive the measurement information, and to send at least part of the measurement information to location server 183, e.g., as described below.

In some demonstrative embodiments, location processing component 145 may be configured to control, cause, instruct and/or trigger node 102 to send the measurement information to location server 183 via MME 127, for example, using the S1-MME interface 193, e.g., as described below.

In some demonstrative embodiments, location processing component 145 may be configured to control, cause, instruct and/or trigger node 102 to send the measurement information to location server 183, for example, via SLm interface 198. For example, network interface 146 may include an SLm interface component 125 configured to communicate with location server 183, e.g., via SLm interface 198.

In some demonstrative embodiments, location processing component 145 may be configured to control, cause, instruct and/or trigger node 102 to receive the measurement information from UE 119, for example, via one or more Radio Resource Control (RRC) messages, e.g., as described below.

In some demonstrative embodiments, location processing component 145 may be configured to control, cause, instruct and/or trigger node 102 to receive the measurement information from WLAN AP 106, for example, via one or more messages, e.g., Xw Application Protocol (XwAP) messages, which may be communicated via Xw interface 199, e.g., as described below.

In some demonstrative embodiments, the measurement information may include FTM measurement information, for example, of, one or more FTM procedures between UE 119 and one or more WLAN APs 106, e.g., as described below.

In some demonstrative embodiments, the measurement information may include RSSI information, for example, bacon RSSI information, e.g., as measured by UE 119 with respect to beacons received from one or more WLAN APs 106, e.g., as described below.

In some demonstrative embodiments, location processor 183 may include a network interface 174 configured to communicate with one or more network elements of system 100.

In some demonstrative embodiments, network interface 174 may include an SLm interface component 175 configured to communicate with node 102, e.g., via SLm interface 198, e.g., as described below.

In some demonstrative embodiments, network interface 174 may include an S1 interface component 176 configured to communicate with MME 127, e.g., via an S1 interface, e.g., as described below. For example, location server 183 may use S1 interface 176 to communicate with node 102, e.g., via MME 127.

In some demonstrative embodiments, location server 183 may include a location processor component 177 configured to process the measurement information received from node 102, for example, to determine a location of UE 119, a mapped location of UE 119, a range of UE 119, and/or any other positioning information relating to the location of UE 119, e.g., as described below.

In some demonstrative embodiments, at least part of the functionality of location processing component 145 may be implemented by an integrated circuit, for example, a chip, e.g., a System on Chip (SoC). In one example, the chip or SoC may be configured to perform one or more functionalities of cellular transceiver 167, WLAN AP interface 169, and/or network interface 146. For example, the chip or SoC may include one or more elements of location processing component 145, and/or one or more elements of cellular transceiver 167, WLAN AP interface 169, and/or network interface 146. In other embodiments, location processing component 145, cellular transceiver 167, WLAN AP interface 169, and/or network interface 146 may be implemented by one or more additional or alternative elements of node 102.

In some demonstrative embodiments, at least part of the functionality of location processor component 177 may be implemented by an integrated circuit, for example, a chip, e.g., a System on Chip (SoC). In one example, the chip or SoC may be configured to perform one or more functionalities of network interface 174. For example, the chip or SoC may include one or more elements of location processor component 177, and/or one or more elements of network interface 174. In other embodiments, location processor component 177 and/or network interface 176 may be implemented by one or more additional or alternative elements of location server 183.

In some demonstrative embodiments, node 102, UE 119, WLAN AP 106, and/or location server 183 may also include, for example, one or more of a processor, an input unit, an output unit, a memory unit, and/or a storage unit. For example, node 102 may include a processor 133, a storage 132 and/or a memory 131; and/or location server 183 may include a processor 135, a storage 136 and/or a memory 134. Node 102, UE 119, WLAN AP 106, and/or location server 183 may optionally include other suitable hardware components and/or software components. In some demonstrative embodiments, some or all of the components of one or more of node 102, UE 119, WLAN AP 106, and/or location server 183 may be enclosed in a common housing or packaging, and may be interconnected or operably associated using one or more wired or wireless links. In other embodiments, components of one or more of node 102, UE 119, WLAN AP 106, and/or location server 183 may be distributed among multiple or separate devices.

In some demonstrative embodiments, processors 133 and/or 135 may include, for example, a Central Processing Unit (CPU), a Digital Signal Processor (DSP), one or more processor cores, a single-core processor, a dual-core processor, a multiple-core processor, a microprocessor, a host processor, a controller, a Plurality of processors or controllers, a chip, a microchip, one or more circuits, circuitry, a, logic unit, an Integrated Circuit (IC), an Application-Specific IC (ASIC), or any other suitable multi-purpose or specific processor or controller. For example, processor 133 may execute instructions, for example, of an Operating System (OS) of node 102 and/or of one or more suitable applications; and/or processor 135 may execute instructions of an OS of location server 183 and/or of one or more suitable applications.

In some demonstrative embodiments, memory unit 131 and/or memory unit 134 may include, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 132 and/or storage unit 136 includes, for example, a hard disk drive, a floppy disk drive, a Compact Disk (CD) drive, a CD-ROM drive, a DVD drive, or other suitable removable or non-removable storage units. For example, memory unit 131 and/or storage unit 132 may store data processed by node 102; and/or memory unit 134 and/or storage unit 136 may store data processed by location processor 183.

In some demonstrative embodiments, location server 183 may be configured to provide to UE 119 assistance data 151, for example, via node 102, via one or more other nodes, and/or any other network element. For example, communication between location server 183 and UE 119 may take place over one or more network components, e.g., including node 102, and/or any other network component.

In some demonstrative embodiments, assistance data 151 may include information configured to enable UE 119 to perform one or more ranging, location, and/or positioning measurements, for example, with one or more WLAN APs 106, and/or to determine one or more values relating based on the ranging, location, and/or positioning measurements.

In some demonstrative embodiments, UE 119 may transmit to node 102 one or more messages, e.g., RRC messages, including measurement information 152, which may be based on the one or more ranging, location, and/or positioning measurements, e.g., as described below.

In some demonstrative embodiments, measurement information 152 may include for example, WLAN measurement information, which may be based, for example, at least on a range between UE 119 and the one or more WLAN APs 106, e.g., as described below.

In some demonstrative embodiments, measurement information 152 may include, for example, information, which may allow determining a location, e.g., a two-dimensional (2D) location, and/or a three-dimensional (3D) location, of UE 119.

In some demonstrative embodiments, UE 119 may be configured to determine an estimated location, e.g., a 2D location, and/or a 3D location, of UE 119, and measurement information 152 may include an indication of the estimated location of UE 119.

In some demonstrative embodiments, node 102 may be configured to send the measurement information 152 to location server 183, which may be configured to process measurement information 152, for example, to determine a location, a mapped location, a range, and/or any other information relating to the location of UE 119, for example, based on the measurement information 152.

In some demonstrative embodiments, location processing component 145 may include LMU component 143, which may be configured, for example, to process positioning of UE 119, for example, based on the measurement information 152, and to provide to location server 183 positioning information resulting from the processing of the measurement information 152.

In some demonstrative embodiments, a positioning process in which the measurement information 152 is provided to location server 183 for calculation of the location of UE 119 may be referred to as a UE-assisted positioning process.

In some demonstrative embodiments, the measurement information 152 may include, and/or may be based on one or more values and/or results of an FTM process, e.g., as described below.

In some demonstrative embodiments, UE 119 may be configured to perform one or more measurements according to an FTM protocol, for example, in accordance with an IEEE 802.11 Specification, e.g., an IEEE 802.11RevMC Specification and/or any other specification and/or protocol.

In some demonstrative embodiments, UE 119 may be configured to perform one or more operations of an FTM initiator to perform one or more FTM measurements with one or more FTM responders, e.g., WLAN APs 106.

In some demonstrative embodiments, UE 119 may be configured to perform one or more proximity, ranging, and/or location estimation measurements, e.g., in an indoor location, based on the FTM measurements. For example, the FTM measurements may provide a relatively accurate estimation of location, range and/or proximity, e.g., in an indoor location.

Some demonstrative embodiments are described herein with respect to a UE, e.g., UE 119, configured to perform measurements according to an FTM protocol and/or procedure. However, in other embodiments, the UE may be configured to perform any other additional or alternative type of Time of Flight (ToF) measurements, ranging measurements, proximity measurements, positioning measurements, and/or location estimation measurements, e.g., according to any additional or alternative protocol and/or procedure.

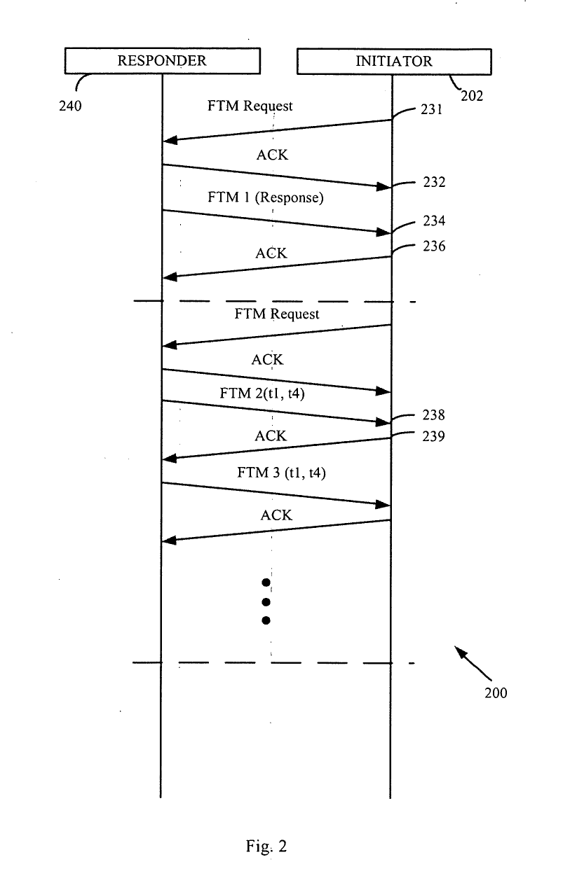

Reference is made to FIG. 2, which schematically illustrates a sequence diagram, which demonstrates operations and interactions between a first wireless communication device 202 (“Initiating STA” or “initiator”) and a second wireless communication device 240 (“Responding STA” or “responder”), of an FTM procedure 200, in accordance with some demonstrative embodiments. For example, device 202 may perform the functionality of UE 119 (FIG. 1), and/or device 240 may perform the functionality of a WLAN AP 106 (FIG. 1).

As shown in FIG. 2, device 202 may transmit to device 240 an FTM request message 231 to request to perform the FTM procedure 200 with device 240.

As shown in FIG. 2, device 240 may transmit an FTM request acknowledgement (ACK) 232 to device 202, to acknowledge receipt of the FTM request message 231, and to confirm the request to perform the FTM procedure.

As shown in FIG. 2, FTM procedure 200 may include an FTM measurement period, during which devices 202 and 240 may communicate FTM measurement frames, e.g., as described below.

In some demonstrative embodiments, devices 202 and/or 240 may communicate the FTM measurement frames between devices 202 and 240 during the FTM measurement period, for example, to determine a Time of Flight (ToF) value between devices 202 and 240.

In some demonstrative embodiments, as shown in FIG. 2, device 240 may transmit an FTM message 234 to device 202, at a time, denoted t1. The time t1 may be a Time of Departure (ToD), denoted ToD(M), of message 234.

In some demonstrative embodiments, as shown in FIG. 2, device 202 may receive message 234 and may determine a time, denoted t2, e.g., by determining a Time of Arrival (ToA), denoted ToA(M), of message 234.

In some demonstrative embodiments, as shown in FIG. 2, device 202 may transmit a message 236 to device 240, at a time, denoted t3. Message 236 may include, for example, an acknowledgement message transmitted in response to FTM message 234. The time t3 may be a ToD, denoted ToD(ACK), of the message 236.

In some demonstrative embodiments, as shown in FIG. 2, device 240 may receive message 236 and may determine a time, denoted t4, e.g., by determining a ToA, denoted ToA(ACK), of message 236.

In some demonstrative embodiments, as shown in FIG. 2, device 240 may transmit an FTM message 238 to device 202. Message 238 may include, for example, information corresponding to the time t1 and/or the time t4. For example, message 238 may include a timestamp, e.g., a ToD timestamp, including the time t1, and a timestamp, e.g., a ToA timestamp, including the time t4.

In some demonstrative embodiments, as shown in FIG. 2, device 202 may receive message 238.

In some demonstrative embodiments, as shown in FIG. 2, device 202 may transmit a message 239 to device 240. Message 239 may include, for example, an acknowledgement message transmitted in response to message 238.

In some demonstrative embodiments, a ToF may be determined between device 202 and device 240, for example, based on message 238.

For example, the ToF may be determined based on an average, or any other function, applied to the time values t1, t2, t3 and t4. For example, the ToF may be determined, e.g., as follows:

ToF=[(t4−t1)−(t3−t2)]/2 (1)

In some demonstrative embodiments, a distance between devices 202 and 240 may be determined, for example, based on the calculated ToF.

For example, the distance, denoted rₖ, may be determined, e.g., as follows:

rₖ=ToF*c (2)

wherein C denotes the radio wave propagation speed.

Referring back to FIG. 1, in some demonstrative embodiments, UE 119 may be configured to transmit to node 102 the measurement information 152 including one or more values of the FTM procedure of FIG. 1, for example, one or more of the values t1, t2, t3 and t4.

In some demonstrative embodiments, UE 119 may be configured to determine the range or distance between UE 119 and a WLAN AP 106, for example, according to Equations 1 and/or 2, and to transmit to node 102 the measurement information 152 including the determined range or distance between UE 119 and a WLAN AP 106.

In some demonstrative embodiments, a location of UE 119, e.g., an absolute location of UE 119, may be determined based on the estimated range rₖ.

For example, the UE 119 may determine two or more ToF values and/or range values, e.g., according to Equations 1 and/or 2, with respect to two or more respective WLAN APs 106, e.g., at least three or four WLAN APs 106.

In some demonstrative embodiments, the location of UE 119 may be determined based on the two or more ToF values, for example, by trilateration.

In some demonstrative embodiments, node 102 may send to location server 183 the measurement information 152, for example, including the values of the FTM measurements, the ToF values and/or the estimated ranges according to Equations 1 and/or 2, for example, with respect to one or more WLAN APs 106, e.g., three or more WLAN APs 106.

In some demonstrative embodiments, location processor 177 may be configured to determine the location of UE 119, for example, based on measurement information corresponding to the measurements between UE 119 and the one or more WLAN APs 106, e.g., by trilateration, for example, using location information corresponding to the locations of the one or more WLAN APs 106.

In some demonstrative embodiments, E-SMLC 171 may be configured to request WLAN based petitioning information from an eNB, e.g., node 102, for example, using an enhanced LPPa protocol on the SLs and S1 interfaces, or using an enhanced SlmAP on the Slm interface 198, e.g., as described below.

In some demonstrative embodiments, location processor component 177 may be configured to generate a request message addressed to an eNB, e.g., node 102. The request message may include for example, an identifier of a UE, e.g., an identifier of UE 119, and a request for WLAN measurements corresponding:to the UE, e.g., as described below.

In some demonstrative embodiments, location processor component 177 may be configured to cause, trigger, request and/or instruct network interface 174 to send the request message to the eNB.

In one example, the request message may include an SLm message, e.g., an SlmAP message. For example, location processor component 177 may be configured to cause, trigger, request and/or instruct SLm interface component 175 to send the request message to the node 102 via SLm interface 198.

In another example, the request message may include an LPPa message. For example, location processor component 177 may be configured to cause, trigger, request and/or instruct S1 interface component 176 to send the request message to the node 102 via the S1 interface with MME 127.

In some demonstrative embodiments, network interface 146 may be configured to receive the request message from location server 183. In one example, SLm interface component 125 may receive the request message via SLm interface 198, for example, if the request message is an SLm message. In another example, S1 interface component 124 may receive the request message via MME 127, for example, if the request message is an LPPa message.

In some demonstrative embodiments, the eNB, e.g., node 102, may be configured to request WLAN measurements, for example, from UE 119 and/or from one or more WLAN APs 106, e.g., as described below.

In some demonstrative embodiments, location processing component 145 may be configured to trigger node 102 to send a measurement request to at least one measurement provider, for example, at least one UE 119, and/or at least one WLAN AP 106.

In some demonstrative embodiments, node 102 may be configured to request WLAN measurements, for example, from UE 119, e.g., using one or more enhanced RRC messages, e.g., via an LTE-Uu interface. For example, location processing component 145 may be configured to trigger cellular transceiver 167 to send a measurement request to UE 119.

In some demonstrative embodiments, UE 119 may perform one or more WLAN measurements with one or more WLAN APs 106, for example, according to the FTM procedure described above with reference to FIG. 2, according to a beacon RSSI procedure, and/or according to any other WLAN location measurement procedure.

In some demonstrative embodiments, UE 119 may transit to node 102 the WLAN measurement information 152, for example, based on the one or more WLAN measurements with one or more WLAN APs 106, e.g., as described above.

In some demonstrative embodiments, node 102 may be configured to request WLAN measurements, for example, from WLAN AP 106, e.g., using one or more enhanced Xw-AP messages, e.g., via Xw interface 199. For example, location processing component 145 may be configured to trigger WLAN AP interface 169 to send a measurement request to WLAN AP 106.

In some demonstrative embodiments, WLAN AP 106 may perform one or more WLAN measurements with UE 119, for example, according to the FTM procedure described above with reference to FIG. 2, according to an RSSI procedure, and/or according to any other WLAN location measurement procedure.

In some demonstrative embodiments, WLAN AP 106 may send to node 102 the WLAN measurement information 153, e.g., via Xw interface 198, for example, based on the one or more WLAN measurements with UE 119, e.g., as described above.

In some demonstrative embodiments, the eNB, e.g., node 102, may be configured to send the measurement information back to E-SMLC 171, for example, using one or more LPPa messages, e.g., according to an enhanced LPPa protocol, and/or using one or more SLmAP messages, e.g., according to an enhanced SlmAP protocol.

In some demonstrative embodiments, location processing component 145 may be configured to trigger node 102 to receive the WLAN measurement information from the at least one measurement provider. For example, the measurement information may include information, which may be based at least on the range between UE 119 and WLAN AP 106, e.g., as described above.

In one example, node 102 may receive measurement information 153 from WLAN AP 106, for example, via Xw interface 199. For example, the measurement information may include information, which may be based at least on the range between UE 119 and WLAN AP 106, e.g., as described above.

In one example, node 102 may receive measurement information 152 from UE 119, for example, via an RRC message. For example, the measurement information may include information, which may be based at least on the range between UE 119 and WLAN AP 106, e.g., as described above.

In some demonstrative embodiments, location processing component 145 may be configured to trigger node 102 to send to location server 183 a response message including the WLAN measurement information.

In one example, location processing component 145 may be configured to trigger S1 interface component 124 to send a response message including the WLAN measurement information, e.g., an LPPa response message, to location server 183, for example, via MME 127.

In another example, location processing component 145 may be configured to trigger SLm interface component 125 to send a response message including the WLAN measurement information, e.g., an SLmAP response message, to location server 183, for example, via SLm interface 198.

In some demonstrative embodiments, node 102 and/or location processor 183 may be configured to communicate the WLAN measurement information according to an LPPa procedure, for example, an enhanced LPPa procedure, e.g., as described below.

In some demonstrative embodiments, one or more procedures, e.g., class 1 and/or class 2 elementary procedures, may be defined for the LPPa protocol, e.g., as described below.

In some demonstrative embodiments, the one or more LPPa procedures may include, for example, one or more of the following procedures:

TABLE 1
Class 1 Elementary Procedures

| | | Successful | Unsuccessful |
|---|---|---|---|
| Elementary | Initiating | Outcome | Outcome |
| Procedure | Message | Response message | Response message |
| E-CID | E-CID | E-CID | E-CID |
| Measurement | MEASUREMENT | MEASUREMENT | MEASUREMENT |
| Initiation | INITIATION | INITIATION | INITIATION |
| | REQUEST | RESPONSE | FAILURE |
| OTDOA | OTDOA | OTDOA | OTDOA |
| Information | INFORMATION | INFORMATION | INFORMATION |
| Exchange | REQUEST | RESPONSE | FAILURE |
| UTDOA | UTDOA | UTDOA | UTDOA |
| Information | INFORMATION | INFORMATION | INFORMATION |
| Exchange | REQUEST | RESPONSE | FAILURE |
| WLAN | WLAN | WLAN | WLAN |
| Measurement | MEASUREMENT | MEASUREMENT | MEASUREMENT |
| Initiation | INITIATION | INITIATION | INITIATION |
| | REQUEST | RESPONSE | FAILURE |

TABLE 2
Class 2 Elementary Procedures

| Elementary Procedure | Initiating Message |
|---|---|
| E-CID Measurement Failure | E-CID MEASUREMENT |
| Indication | FAILURE INDICATION |
| E-CID Measurement Report | E-CID MEASUREMENT |
| | REPORT |
| E-CID Measurement | E-CID MEASUREMENT |
| Termination | TERMINATION COMMAND |
| UTDOA Information Update | UTDOA INFORMATION |
| | UPDATE |
| Error Indication | ERROR INDICATION |
| WLAN Measurement | WLAN MEASUREMENT |
| Failure Indication | FAILURE INDICATION |
| WLAN Measurement Report | WLAN MEASUREMENT REPORT |
| WLAN Measurement | WLAN MEASUREMENT |
| Termination | TERMINATION |

In some demonstrative embodiments, the LPPa procedure may be enhanced to include a WLAN measurement initiation procedure.

In some demonstrative embodiments, WLAN measurement initiation procedure may be initiated, for example, by location server 183, by sending a WLAN measurement initiation request message, e.g., as described below.

In some demonstrative embodiments, node 102 may be configured to send to location server 183 a WLAN measurement initiation response message, for example, to provide to location server 183 WLAN measurement information successfully received from UE 119 and/or WLAN AP 106, e.g., as described below.

In some demonstrative embodiments, node 102 may be configured to send to location server 183 a WLAN measurement report message, for example, to periodically provide to location server 183 WLAN measurement information successfully received from UE 119 and/or WLAN AP 106, e.g., as described below.

In some demonstrative embodiments, node 102 may be configured to send to location server 183 a WLAN measurement initiation failure message, for example, to indicate that WLAN measurement information was not successfully received from UE 119 and/or WLAN AP 106, e.g., as described below.

In some demonstrative embodiments, node 102 may be configured to send to location server 183 a WLAN measurement failure indication message, for example, to indicate that WLAN measurement information was not successfully received from UE 119 and/or WLAN AP 106, e.g., as described below.

In some demonstrative embodiments, node 102 may be configured to communicate with location server 183 a WLAN measurement termination message, for example, to terminate the WLAN measurements, e.g., as described below.

In some demonstrative embodiments, E-SMLC 171 may be configured to send the WLAN MEASUREMENT INITIATION REQUEST message to node 102, for example, to indicate that node 102 is to initiate WLAN measurements.

In some demonstrative embodiments, E-SMLC 171 may be configured to include in the WLAN MEASUREMENT INITIATION REQUEST message an indication of a type of WLAN measurements to be performed, for example, a first indication to indicate a request for WLAN Beacon RSSI measurements, a second indication to indicate a request for WLAN FTM measurements, and/or any other indication to indicate any other additional or alternative type of WLAN measurements, and./or a combination thereof.

In some demonstrative embodiments, node 102 may be configured to request UE 119 to perform the WLAN measurements, for example, using one or more RRC messages, e.g., a RRCConnectionReconfiguration messages and/or any other RRC messages. For example, node 102 may request UE 119 to perform WLAN measurements with multiple WLAN APs 106, e.g., as described above.

In some demonstrative embodiments, node 102 may be configured to request one or more WLAN APs 106 for the WLAN measurements, for example, via Xw interface 199, e.g., as described above. In one example, node 102 may be configured to map a 3GPP identity of UE 119, for example, to a WLAN MAC address of UE 119. In one example, WLAN AP 106 may support WLAN measurement reporting, for example, in accordance with an IEEE 802.11 Specification, e.g., IEEE 802.11k-2008 and/or IEEE 802.11-2012.

In some demonstrative embodiments, node 102 may be configured to receive and/or collect the WLAN measurement information, e.g., as described above.

In some demonstrative embodiments, node 102 may be configured to respond with a response message including the WLAN measurements, for example, the WLAN MEASUREMENT INITIATION RESPONSE message, or the WLAN MEASUREMENT INITIATION FAILURE message, e.g., as described above, for example, if the WLAN MEASUREMENT INITIATION REQUEST indicated an “on demand” or “one shot” request for the WLAN measurements.

In some demonstrative embodiments, node 102 may be configured to respond with a response message including the WLAN measurements, for example, the WLAN MEASUREMENT REPORT message, for example, if the WLAN MEASUREMENT INITIATION REQUEST indicated a request for periodic measurements, in which node 102 is requested to periodically report the WLAN measurements.

In some demonstrative embodiments, the WLAN measurements may be terminated, e.g., by node 102 and/or by E-SMLC 171, for example, using the WLAN MEASUREMENT TERMINATION message.

In some demonstrative embodiments the WLAN MEASUREMENT REPORT message may include, for example, one or more of the following fields, and/or may have the following format:

9.1.1.x WLAN Measurement Report
This message is sent by eNB to report the results of the requested WLAN measurement.
Direction: eNB→E-SMLC.

TABLE 3

| | | | | | | |
|---|---|---|---|---|---|---|
| IE/Group | | | IE type and | Semantics | | Assigned |
| Name | Presence | Range | reference | description | Criticality | Criticality |

| | | | | |
|---|---|---|---|---|
| Message | M | 9.2.3 | YES | ignore |
| Type | | | | |
| LPPa | M | 9.2.4 | — | |
| Transaction | | | | |
| ID | | | | |
| E-SMLC UE | M | INTEGER | YES | reject |
| Measurement | | (1 . . . 15, . . .) | | |
| ID | | | | |
| eNB UE | M | INTEGER | YES | reject |
| Measurement | | (1 . . . 15, . . .) | | |
| ID | | | | |
| WLAN | M | 9.2.5 | YES | ignore |
| Measurement | | | | |
| Result | | | | |

In some demonstrative embodiments, the WLAN measurement result IE of Table 3 may include, for example, one or more of the following fields, and/or may have the following format:

9.2.y WLAN Measurement Result
The purpose of the WLAN Measurement Result information element is to provide the WLAN measurement result.

TABLE 4

| IE/Group | | | IE Type and | Semantics |
|---|---|---|---|---|
| Name | Presence | Range | Reference | Description |
| Measured | | 0 . . . <maxnoMeas> | | |
| Results | | | | |
| >BSSID | M | | OCTET | |
| | | | STRING | |
| | | | (SIZE(6)) | |
| >Range | M | | INTEGER | Indicates the |
| | | | | estimated range |
| | | | | to the AP |

In some demonstrative embodiments, node 102 and/or location processor 183 may be configured to communicate the WLAN measurement information according to an SLm procedure, for example, an enhanced SLmAP procedure, e.g., as described below.

In some demonstrative embodiments, one or more procedures may be defined for the SLmAP protocol, e.g., as described below.

In some demonstrative embodiments, WLAN measurements may be initiated, for example, by location server 183, by sending a WLAN measurement request, e.g., as described below.

In some demonstrative embodiments, node 102 may be configured to send to location server 183 a WLAN measurement response, for example, to provide to location server 183 WLAN measurement information successfully received from UE 119 and/or WLAN AP 106, e.g., as described below.

In some demonstrative embodiments, node 102 may be configured to send to location server 183 a WLAN measurement failure message, for example, to indicate that WLAN measurement information was not successfully received from UE 119 and/or WLAN AP 106, e.g., as described below.

In some demonstrative embodiments, WLAN measurement response message may include, for example, one or more of the following fields, and/or may have the following format:

9.1.2 Measurement Response

This message is sent by the LMU to report UL RTOA measurements for the target UE.

Direction: LMU→E-SMLC.

TABLE 5

| | | | | | | |
|---|---|---|---|---|---|---|
| IE/Group | | | IE type and | Semantics | | Assigned |
| Name | Presence | Range | reference | description | Criticality | Criticality |

| | | | | |
|---|---|---|---|---|
| Message | M | 9.2.2 | YES | reject |
| Type | | | | |
| SlmAP | M | 9.2.3 | — | |
| Transaction | | | | |
| ID | | | | |
| E-SMLC | M | 9.2.12 | YES | reject |
| Measurement | | | | |
| ID | | | | |
| UL RTOA | M | 9.2.5 | YES | reject |
| measurements | | | | |
| Criticality | O | 9.2.11 | YES | ignore |
| Diagnostics | | | | |
| WLAN | O | 9.2.z | YES | ignore |
| measurements | | | | |

In some demonstrative embodiments, the WLAN measurement IE of Table 5 may include, for example, one or more of the following fields, and/or may have the following format:

9.2.z WLAN Measurements
The purpose of the WLAN Measurements IE is to signal WLAN measurement results to the E-SMLC.

TABLE 6

| IE/Group | | | IE Type and | Semantics |
|---|---|---|---|---|
| Name | Presence | Range | Reference | Description |
| WLANMeasurements | M | <0 . . . maxnoMeas> | | |
| >BSSID | M | | OCTET | |
| | | | STRING | |
| | | | (SIZE(6)) | |
| >Range | M | | INTEGER | Indicates the |
| | | | | estimated range |
| | | | | to the AP |

In some demonstrative embodiments, E-SMLC 171 may be configured to send the WLAN MEASUREMENT REQUEST message to LMU 143 of node 102, for example, to indicate that node 102 is to initiate WLAN measurements.

In some demonstrative embodiments, E-SMLC 171 may be configured to include in the WLAN MEASUREMENT REQUEST message an indication of a type of WLAN measurements to be performed, for example, a first indication to indicate a request for WLAN Beacon RSSI measurements, a second indication to indicate a request for WLAN FTM measurements, and/or any other indication to indicate any other additional or alternative type of WLAN measurements, and./or a combination thereof.

In some demonstrative embodiments, node 102 may be configured to, e.g., based on the WLAN MEASUREMENT REQUEST message, request UE 119 to perform the WLAN measurements, for example, using one or more RRC messages, e.g., a RRCConnectionReconfiguration messages and/or any other RRC messages. For example, node 102 may request UE 119 to perform WLAN measurements with multiple WLAN APs 106, e.g., as described above.

In some demonstrative embodiments, node 102 may be configured to, e.g., based on the WLAN MEASUREMENT REQUEST message, request one or more WLAN APs 106 for the WLAN measurements, for example, via Xw interface 199, e.g., as described above. In one example, node 102 may be configured to map a 3GPP identity of UE 119, for example, to a WLAN MAC address of UE 119. In one example, WLAN AP 106 may support WLAN measurement reporting, for example, in accordance with an IEEE 802.11 Specification, e.g., IEEE 802.11k-2008 and/or IEEE 802.11-2012.

In some demonstrative embodiments, node 102 may be configured to receive and/or collect the WLAN measurement information, e.g., as described above.

In some demonstrative embodiments, node 102 may be configured to respond with a response message including the WLAN measurements, for example, the WLAN MEASUREMENT RESPONSE message, or the WLAN MEASUREMENT FAILURE message, e.g., as described above. For example, LMU 143 may be configured to include the WLAN measurement information in the WLAN MEASUREMENT RESPONSE message.

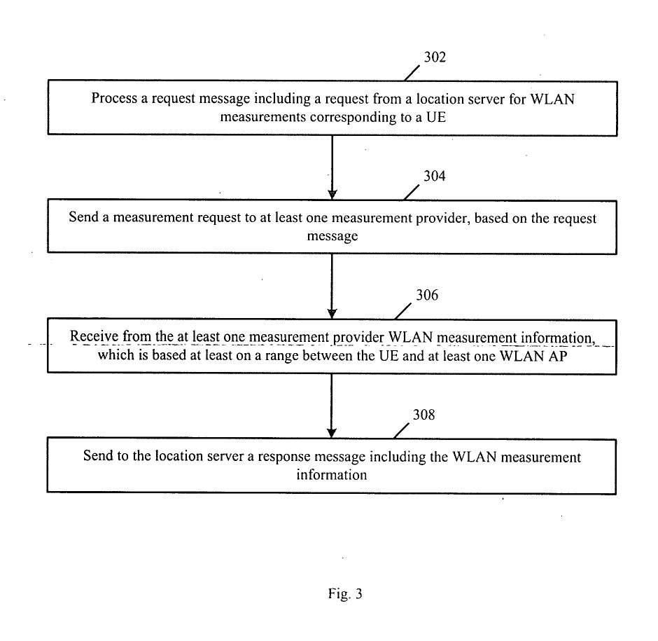

Reference is made to FIG. 3, which schematically illustrates a method of providing WLAN measurement information from a cellular node to a location server, in accordance with some demonstrative embodiments. In some embodiments, one or more of the operations of the method of FIG. 3 may be performed by one or more elements of a system, e.g., system 100 (FIG. 1); a node, e.g., node 102 (FIG. 1); a location server, e.g., location server 183 (FIG. 1); a location processing component, e.g., location processing component 145 (FIG. 1); an LMU, e.g., LMU 143 (FIG. 1), and/or an interface, e.g., interface 167 (FIG. 1), interface 169 (FIG. 1), and/or interface 146 (FIG. 1).

As indicated at block 302, the method may include processing a request message including a request from a location server for WLAN measurements corresponding to a UE. For example, location processing component 145 (FIG. 1) may be configured a WLAN measurements request message from location server 183 (FIG. 1) for obtaining WLAN measurements corresponding to UE 119 (FIG. 1), e.g., as described above.

As indicated at block 304, the method may include sending a measurement request to at least one measurement provider, for example, the UE and/or at least one WLAN AP, e.g., based on the request message. For example, location processing component 145 (FIG. 1) may be configured trigger node 102 (FIG. 1) to send a measurement request to UE 119 (FIG. 1) and/or WLAN AP 106 (FIG. 1), e.g., as described above.

As indicated at block 306, the method may include receiving from the at least one measurement provider WLAN measurement information, which is based at least on a range between the UE and the WLAN AP. For example, location processing component 145 (FIG. 1) may cause, trigger, and/or instruct node 102 (FIG. 1) to receive measurement information 152 (FIG. 1) and/or measurement information 153, (FIG. 1), e.g., as described above.

As indicated at block 308, the method may include sending to the location server a response message including the WLAN measurement information. For example location processing component 145 (FIG. 1) may cause, trigger, and/or instruct node 102 (FIG. 1) to send to location server 183 (FIG. 1) a WLAN measurements response message, e.g., as described above.

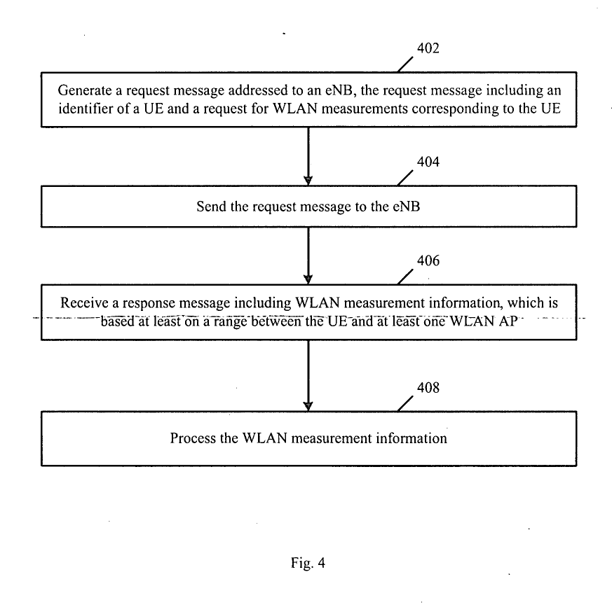

Reference is made to FIG. 4, which schematically illustrates a method of processing WLAN measurement information at a location server, in accordance with some demonstrative embodiments. In some embodiments, one or more of the operations of the method of FIG. 4 may be performed by one or more elements of a system, e.g., system 100 (FIG. 1); a node, e.g., node 102 (FIG. 1); a location server, e.g., location server 183 (FIG. 1); a location processor component, e.g., location processor component 177 (FIG. 1); an LMU, e.g., LMU 172 (FIG. 1), and/or an interface, e.g., interface 174 (FIG. 1).

As indicated at block 402, the method may include generating a request message addressed to an eNB, the request message including an identifier of a UE and a request for WLAN measurements corresponding to the UE. For example, location processor component 177 (FIG. 1) may generate the WLAN measurements request to request node 102 (FIG. 1) for WLAN measurements corresponding to UE 119 (FIG. 1), e.g., as described above.

As indicated at block 404, the method may include sending the request message to the eNB. For example, location processor component 177 (FIG. 1) may trigger, cause, and/or instruct interface 174 (FIG. 1) to send the WLAN measurements request to node 102 (FIG. 1), for example, via SLm interface 198 (FIG. 1) or via MME 127 (FIG. 1), e.g., as described above.

As indicated at block 406, the method may include receiving a response message including WLAN measurement information, which is based at least on a range between the UE and at least one WLAN AP. For example, interface 174 (FIG. 1) may receive the WLAN measurements response from node 102 (FIG. 1), for example, via SLm interface 198 (FIG. 1) or via MME 127 (FIG. 1), e.g., as described above.

As indicated at block 408, the method may include processing the WLAN measurement information. For example, location processor component 177 (FIG. 1) may process the WLAN measurement information received form node 102 (FIG. 1), e.g., as described above.

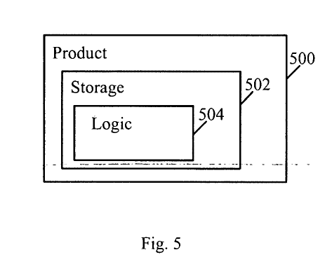

Reference is made to FIG. 5, which schematically illustrates a product of manufacture 500, in accordance with some demonstrative embodiments. Product 500 may include one or more tangible computer-readable non-transitory storage media 502, which may include computer-executable instructions, e.g., implemented by logic 504, operable to, when executed by at least one computer processor, enable the at least one computer processor to implement one or more operations at a node, for example, an eNB, e.g., node 102 (FIG. 1), a location server, e.g., location server 183 (FIG. 1); a location processing component, e.g., location processing component 145 (FIG. 1) and/or location processor component 177 (FIG. 1); and/or to perform, trigger and/or implement one or more operations and/or functionalities discussed above, e.g., including one or more operations discussed above with reference to FIG. 2, 3 and or 4. The phrase “non-transitory machine-readable medium” is directed to include all computer-readable media, with the sole exception being a transitory propagating signal.

In some demonstrative embodiments, product 500 and/or machine-readable storage medium 502 may include one or more types of computer-readable storage media capable of storing data, including volatile memory, non-volatile memory, removable or non-removable memory, erasable or non-erasable memory, writeable or re-writeable memory, and the like. For example, machine-readable storage medium 502 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, is magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 504 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 504 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### EXAMPLES

The following examples pertain to further embodiments.

Example 1 includes an apparatus of an Evolved Node B (eNB), the apparatus comprising a network interface configured to receive a request message, the request message comprising a request from a location server for Wireless Local Area Network (WLAN) measurements corresponding to a User Equipment (UE); and a location processing component configured to trigger the eNB to send a measurement request to at least one measurement provider selected from a group consisting of the UE and at least one WLAN Access Point (AP), the location processing component configured to receive from the at least one measurement provider WLAN measurement information, which is based at least on a range between the UE and the WLAN AP, the location processing component configured to trigger the eNB to send to the location server a response message including the WLAN measurement information.

Example 2 includes the subject matter of Example 1, and optionally, wherein the measurement provider comprises the UE.

Example 3 includes the subject matter of Example 2, and optionally, wherein the location processing component is configured to trigger the eNB to send to the UE a Radio Resource Control (RRC) message comprising the measurement request.

Example 4 includes the subject matter of Example 2 or 3, and optionally, comprising a cellular transceiver configured to transmit the measurement request to the UE, and to receive the WLAN measurement information from the UE.

Example 5 includes the subject matter of Example 1, and optionally, wherein the measurement provider comprises the WLAN AP.

Example 6 includes the subject matter of Example 5, and optionally, comprising a WLAN AP interface configured to send the measurement request to the WLAN AP, and to receive the WLAN measurement information from the WLAN AP.

Example 7 includes the subject matter of any one of Examples 1-6, and optionally, wherein the WLAN measurement information comprises at least one Fine Timing Measurement (FTM) between the UE and the WLAN AP.

Example 8 includes the subject matter of any one of Examples 1-7, and optionally, wherein the WLAN measurement information comprises at least one Received Signal Strength Indication (RSSI) corresponding to signals communicated between the UE and the WLAN AP.

Example 9 includes the subject matter of any one of Examples 1-8, and optionally, wherein the request message and the response message comprise Long Term Evolution (LTE) Positioning Protocol A (LPPa) messages.

Example 10 includes the subject matter of any one of Examples 1-8, and optionally, wherein the request message and the response message comprise SLm Application Protocol (SLmAP) messages.

Example 11 includes the subject matter of any one of Examples 1-8, and optionally, wherein the network interface comprises an SLm interface configured to communicate with the location server.

Example 12 includes the subject matter of Example 11, and optionally, wherein the location processing component comprises a Location Management Unit (LMU) to process positioning of the UE based on the WLAN measurement information.

Example 13 includes the subject matter of any one of Examples 1-8, and optionally, wherein the network interface comprises an S1 interface configured to communicate with the location server via a Mobility Management Entity (MME).

Example 14 includes the subject matter of any one of Examples 1-13, and optionally, wherein the location server comprises an Evolved Serving Mobile Location Centre (E-SMLC).

Example 15 includes the subject matter of any one of Examples 1-14, and optionally, comprising one or more antennas, a memory and a processor.

Example 16 includes an apparatus comprising circuitry and logic configured to trigger an Evolved Node B (eNB) to process a request message comprising a request from a location server for Wireless Local Area Network (WLAN) measurements corresponding to a User Equipment (UE); based on the request message, send a measurement request to at least one measurement provider selected from a group consisting of the UE and at least one WLAN Access Point (AP); receive from the at least one measurement provider WLAN measurement information, which is based at least on a range between the UE and the WLAN AP; and send to the location server a response message including the WLAN measurement information.

Example 17 includes the subject matter of Example 16, and optionally, wherein the measurement provider comprises the UE.

Example 18 includes the subject matter of Example 17, and optionally, wherein the apparatus is configured to trigger the eNB to send to the UE a Radio Resource Control (RRC) message comprising the measurement request.

Example 19 includes the subject matter of Example 17 or 18, and optionally, comprising a cellular transceiver configured to transmit the measurement request to the UE, and to receive the WLAN measurement information from the UE.

Example 20 includes the subject matter of Example 16, and optionally, wherein the measurement provider comprises the WLAN AP.

Example 21 includes the subject matter of Example 20, and optionally, comprising a WLAN AP interface configured to send the measurement request to the WLAN AP, and to receive the WLAN measurement information from the WLAN AP.

Example 22 includes the subject matter of any one of Examples 16-21, and optionally, wherein the WLAN measurement information comprises at least one Fine Timing Measurement (FTM) between the UE and the WLAN AP.

Example 23 includes the subject matter of any one of Examples 16-22, and optionally, wherein the WLAN measurement information comprises at least one Received Signal Strength Indication (RSSI) corresponding to signals communicated between the UE and the WLAN AP.

Example 24 includes the subject matter of any one of Examples 16-23, and optionally, wherein the request message and the response message comprise Long Term Evolution (LTE) Positioning Protocol A (LPPa) messages.

Example 25 includes the subject matter of any one of Examples 16-23, and optionally, wherein the request message and the response message comprise SLm Application Protocol (SLmAP) messages.

Example 26 includes the subject matter of any one of Examples 16-23, and optionally, comprising an SLm interface configured to communicate with the location server.

Example 27 includes the subject matter of Example 26, and optionally, comprising a Location Management Unit (LMU) to process positioning of the UE based on the WLAN measurement information.

Example 28 includes the subject mater of any one of Examples 16-23, and optionally, comprising an S1 interface configured to communicate with the location server via a Mobility Management Entity (MME).

Example 29 includes the subject matter of any one of Examples 16-28, and optionally, wherein the location server comprises an Evolved Serving Mobile Location Centre (E-SMLC).

Example 30 includes the subject matter of any one of Examples 16-29, and optionally, comprising one or more antennas, a memory and a processor.

Example 31 includes a system of cellular communication comprising an Evolved Node B (eNB), the eNB comprising one or more antennas; a memory; a processor; a network interface configured to receive a request message, the request message comprising a request from a location server for Wireless Local Area Network (WLAN) measurements corresponding to a User Equipment (UE); and a location processing component configured to trigger the eNB to send a measurement request to at least one measurement provider selected from a group consisting of the UE and at least one WLAN Access Point (AP), the location processing component configured to receive from the at least one measurement provider WLAN measurement information, which is based at least on a range between the UE and the WLAN AP, the location processing component configured to trigger the eNB to send to the location server a response message including the WLAN measurement information.

Example 32 includes the subject matter of Example 31, and optionally, wherein the measurement provider comprises the UE.

Example 33 includes the subject matter of Example 32, and optionally, wherein the location processing component is configured to trigger the eNB to send to the UE a Radio Resource Control (RRC) message comprising the measurement request.

Example 34 includes the subject matter of Example 32 or 33, and optionally, wherein the eNB comprises a cellular transceiver configured to transmit the measurement request to the UE, and to receive the WLAN measurement information from the UE.

Example 35 includes the subject matter of Example 31, and optionally, wherein the measurement provider comprises the WLAN AP.

Example 36 includes the subject matter of Example 35, and optionally, wherein the eNB comprises a WLAN AP interface configured to send the measurement request to the WLAN AP, and to receive the WLAN measurement information from the WLAN AP.

Example 37 includes the subject matter of any one of Examples 31-36, and optionally, wherein the WLAN measurement information comprises at least one Fine Timing Measurement (FTM) between the UE and the WLAN AP.

Example 38 includes the subject miter of any one of Examples 31-37, and optionally, wherein the WLAN measurement information comprises at least one Received Signal Strength Indication (RSSI) corresponding to signals communicated between the UE and the WLAN AP.

Example 39 includes the subject matter of any one of Examples 31-38, and optionally, wherein the request message and the response message comprise Long Term Evolution (LTE) Positioning Protocol A (LPPa) messages.

Example 40 includes the subject matter of any one of Examples 31-38, and optionally, wherein the request message and the response message comprise SLm Application Protocol (SLmAP) messages.

Example 41 includes the subject matter of any one of Examples 31-38, and optionally, wherein the network interface comprises an SLm interface configured to communicate with the location server.

Example 42 includes the subject matter of Example 41, and optionally, wherein the location processing component comprises a Location Management Unit (LMU) to process positioning of the UE based on the WLAN measurement information.

Example 43 includes the subject matter of any one of Examples 31-38, and optionally, wherein the network interface comprises an S1 interface configured to communicate with the location server via a Mobility Management Entity (MME).

Example 44 includes the subject matter of any one of Examples 31-43, and optionally, wherein the location server comprises an Evolved Serving Mobile Location Centre (E-SMLC).

Example 45 includes a product comprising one or more tangible computer-readable storage media comprising computer-executable instructions operable to, when executed by at least one computer processor, enable the at least one computer processor to implement one or more operations at an Evolved Node B (eNB), the operations comprising processing a request message comprising a request from a location server for Wireless Local Area Network (WLAN) measurements corresponding to a User Equipment (UE); based on the request message, sending a measurement request to at least one measurement provider selected from a group consisting of the UE and at least one WLAN Access Point (AP); receiving from the at least one measurement provider WLAN measurement information, which is based at least on a range between the UE and the WLAN AP; and sending to the location server a response message including the WLAN measurement information.

Example 46 includes the subject matter of Example 45, and optionally, wherein the measurement provider comprises the UE.

Example 47 includes the subject matter of Example 46, and optionally, wherein the operations comprise triggering the eNB to send to the UE a Radio Resource Control (RRC) message comprising the measurement request.

Example 48 includes the subject matter of Example 46 or 47, and optionally, wherein the operations comprise transmitting the measurement request to the UE, and receiving the WLAN measurement information from the UE.

Example 49 includes the subject matter of Example 45, and optionally, wherein the measurement provider comprises the WLAN AP.

Example 50 includes the subject matter of Example 49, and optionally, wherein the operations comprise sending the measurement request to the WLAN AP, and receiving the WLAN measurement information from the WLAN AP.

Example 51 includes the subject matter of any one of Examples 45-50, and optionally, wherein the WLAN measurement information comprises at least one Fine Timing Measurement (FTM) between the UE and the WLAN AP.

Example 52 includes the subject matter of any one of Examples 45-51, and optionally, wherein the WLAN measurement information comprises at least one Received Signal Strength Indication (RSSI) corresponding to signals communicated between the UE and the WLAN AP.

Example 53 includes the subject matter of any one of Examples 45-52, and optionally, wherein the request message and the response message comprise Long Term Evolution (LTE) Positioning Protocol A (LPPa) messages.

Example 54 includes the subject matter of any one of Examples 45-52, and optionally, wherein the request message and the response message comprise SLm Application Protocol (SLmAP) messages.

Example 55 includes the subject matter of any one of Examples 45-52, and optionally, wherein the operations comprise communicating with the location server via an SLm interface.

Example 56 includes the subject matter of Example 55, and optionally; wherein the operations comprise processing positioning of the UE based on the WLAN measurement information.

Example 57 includes the subject matter of any one of Examples 45-52, and optionally, wherein the operations comprise communicating with the location server via a Mobility Management Entity (MME).

Example 58 includes the subject matter of any one of Examples 45-57, and optionally, wherein the location server comprises an Evolved Serving Mobile Location Centre (E-SMLC).

Example 59 includes a method to be performed by an Evolved Node B (eNB), the method comprising processing a request message comprising a request from a location server for Wireless Local Area Network (WLAN); measurements corresponding to a User Equipment (UE); based on the request message; sending a measurement request to at least one measurement provider selected from a group consisting of the UE and at least one WLAN Access Point (AP); receiving from the (at least one measurement provider WLAN measurement information, which is based at least on a range between the UE and the WLAN AP; and sending to the location server a response message including the WLAN measurement information.

Example 60 includes the subject matter of Example 59, and optionally, wherein the measurement provider comprises the UE.

Example 61 includes the subject matter; of Example 60, and optionally, comprising triggering the eNB to send to the UE a Radio Resource Control (RRC) message comprising the measurement request.

Example 62 includes the subject matter of Example 60 or 61, and optionally, comprising transmitting the measurement request to the UE, and receiving the WLAN measurement information from the UE.

Example 63 includes the subject matter of Example 59, and optionally, wherein the measurement provider comprises the WLAN AP.

Example 64 includes the subject matter of Example 63, and optionally, comprising sending the measurement request to the WLAN AP, and receiving the WLAN measurement information from the WLAN AP.

Example 65 includes the subject matter of any one of Examples 59-64, and optionally, wherein the WLAN measurement information comprises at least one Fine Timing Measurement (FTM) between the UE and the WLAN AP.

Example 66 includes the subject matter of any one of Examples 59-65, and optionally, wherein the WLAN measurement information comprises at least one Received Signal Strength Indication (RSSI) corresponding to signals communicated between the UE and the WLAN AP.

Example 67 includes the subject matter of any one of Examples 59-66, and optionally, wherein the request message and the response message comprise Long Term Evolution (LTE) Positioning Protocol A (LPPa) messages.

Example 68 includes the subject matter of any one of Examples 59-66, and optionally, wherein the request message and the response message comprise SLm Application Protocol (SLmAP) messages.

Example 69 includes the subject matter of any one of Examples 59-66, and optionally, comprising communicating with the location server via an SLm interface.

Example 70 includes the subject matter of Example 69, and optionally, comprising processing positioning of the UE based on the WLAN measurement information.

Example 71 includes the subject matter of any one of Examples 59-66, and optionally, comprising communicating with the location server via a Mobility Management Entity (MME).

Example 72 includes the subject matter of any one of Examples 59-71, and optionally, wherein the location server comprises an Evolved Serving Mobile Location Centre (E-SMLC).

Example 73 includes an apparatus of an Evolved Node B (eNB), the apparatus comprising means for processing a request message comprising a request from a location server for Wireless Local Area Network (WLAN) measurements corresponding to a User Equipment (UE); means for, based on the request message, sending a measurement request to at least one measurement provider selected from the group consisting of the UE and at least one WLAN Access Point (AP); means for receiving from the at least one measurement provider WLAN measurement information, which is based at least on a range between the UE and the WLAN AP; and means for sending to the location server a response message including the WLAN measurement information.

Example 74 includes the subject matter of Example 73, and optionally, wherein the measurement provider comprises the UE.

Example 75 includes the subject matter, of Example 74, and optionally, comprising means for triggering the eNB to send to the UE a Radio Resource Control (RRC) message comprising the measurement request.

Example 76 includes the subject matter of Example 74 or 75, and optionally, comprising means for transmitting the measurement request to the UE, and receiving the WLAN measurement information from the UE.

Example 77 includes the subject matter,of Example 73, and optionally, wherein the measurement provider comprises the WLAN AP.

Example 78 includes the subject matter of Example 77, and optionally, comprising means for sending the measurement request to the WLAN AP, and receiving the WLAN measurement information from the WLAN AP.

Example 79 includes the subject matter of any one of Examples 73-78, and optionally, wherein the WLAN measurement information comprises at least one Fine Timing Measurement (FTM) between the UE and the WLAN AP.

Example 80 includes the subject matter of any one of Examples 73-79, and optionally, wherein the WLAN measurement information comprises at least one Received Signal Strength Indication (RSSI) corresponding to signals communicated between the UE and the WLAN AP.

Example 81 includes the subject matter of any one of Examples 73-80, and optionally, wherein the request message and the response message comprise Long Term Evolution (LTE) Positioning Protocol A (LPPa) messages.

Example 82 includes the subject matter of any one of Examples 73-80, and optionally, wherein the request message and the response message comprise SLm Application Protocol (SLmAP) messages.

Example 83 includes the subject matter of any one of Examples 73-80, and optionally, comprising means for communicating with the location server via an SLm interface.

Example 84 includes the subject matter of Example 83, and optionally, comprising means for processing positioning of the UE based on the WLAN measurement information.

Example 85 includes the subject matter of any one of Examples 73-80, and optionally, comprising means for communicating with the location server via a Mobility Management Entity (MME).

Example 86 includes the subject matter of any one of Examples 73-85, and optionally, wherein the location server comprises an Evolved Serving Mobile Location Centre (E-SMLC).

Example 87 includes an apparatus of allocation server, the apparatus comprising a location processor component configured to generate a request message addressed to an Evolved Node B (eNB), the request message comprising an identifier of a User Equipment (UE), and a request for Wireless Local Area Network (WLAN) measurements corresponding to the UE; and a network interface configured to send the request message to the eNB, and to receive a response message including WLAN measurement information, which is based at least on a range between the UE and at least one WLAN AP, the location processor component configured to process the WLAN measurement information.

Example 88 includes the subject matter of Example 87, and optionally, wherein the WLAN measurement information comprises at least one Fine Timing Measurement (FTM) between the UE and the WLAN AP.

Example 89 includes the subject matter of Example 87 or 88, and optionally, wherein the WLAN measurement information comprises at least one Received Signal Strength Indication (RSSI) corresponding to signals communicated between the UE and the WLAN AP.

Example 90 includes the subject matter of any one of Examples 87-89, and optionally, wherein the request message and the response message comprise Long Term Evolution (LTE) Positioning Protocol A (LPPa) messages.

Example 91 includes the subject matter of any one of Examples 87-89, and optionally, wherein the request message and the response message comprise SLm Application Protocol (SLmAP) messages.

Example 92 includes the subject matter of any one of Examples 87-89, and optionally, wherein the network interface comprises an SLm interface configured to communicate with the eNB.

Example 93 includes the subject matter of any one of Examples 87-89, and optionally, wherein the network interface comprises a S1 interface configured to communicate with the eNB via a Mobility Management Entity (MME).

Example 94 includes the subject matter of any one of Examples 87-93, and optionally, comprising an Evolved Serving Mobile Location Centre (E-SMLC).

Example 95 includes the subject matter of any one of Examples 87-94, and optionally, comprising a Location. Management Unit (LMU) to process a location of the UE based on the WLAN measurement information.

Example 96 includes the subject matter of any one of Examples 87-95, and optionally, comprising a memory and a processor.

Example 97 includes an apparatus comprising circuitry and logic configured to trigger a location server to generate a request message addressed to an Evolved Node B (eNB) the request message comprising an identifier of a User Equipment (UE) and a request for Wireless Local Area Network (WLAN) measurements corresponding to the UE; send the request message to the eNB; receive a response message including WLAN measurement information, which is based at least on a range between the UE and at least one WLAN AP; and process the WLAN measurement information.

Example 98 includes the subject matter of Example 97, and optionally, wherein the WLAN measurement information comprises at least one Fine Timing Measurement (FTM) between the UE and the WLAN AP.

Example 99 includes the subject matter of Example 97 or 98, and optionally, wherein the WLAN measurement information comprises at least one Received Signal Strength Indication (RSSI) corresponding to signals communicated between the UE and the WLAN AP.

Example 100 includes the subject matter of any one of Examples 97-99, and optionally, wherein the request message and the response message comprise Long Term Evolution (LTE) Positioning Protocol A (LPPa) messages.

Example 101 includes the subject matter of any one of Examples 97-99, and optionally, wherein the request message and the response message comprise SLm Application Protocol (SLmAP) messages.

Example 102 includes the subject matter of any one of Examples 97-99, and optionally, comprising an SLm interface configured to communicate with the eNB.

Example 103 includes the subject matter of any one of Examples 97-99, and optionally, comprising a S1 interface configured to communicate with the eNB via a Mobility Management Entity (MME).

Example 104 includes the subject matter of any one of Examples 97-103, and optionally, comprising an Evolved Serving Mobile Location Centre (E-SMLC).

Example 105 includes the subject matter of any one of Examples 97-104, and optionally, comprising a Location Management Unit (LMU) to process a location of the UE based on the WLAN measurement information.

Example 106 includes the subject matter of any one of Examples 97-105, and optionally, comprising a memory and a processor.

Example 107 includes a system of cellular communication comprising a location server, the location server comprising a memory; a processor; a location processor component configured to generate a request message addressed to an Evolved Node B (eNB), the request message comprising an identifier of a User Equipment (UE), and a request for Wireless Local Area Network (WLAN) measurements corresponding to the UE; and a network interface configured to send the request message to the eNB, and to receive a response message including WLAN measurement information, which is based at least on a range between the UE and at least one WLAN AP, the location processor component configured to process the WLAN measurement information.

Example 108 includes the subject matter of Example 107, and optionally, wherein the WLAN measurement information comprises at least one Fine Timing Measurement (FTM) between the UE and the WLAN AP.

Example 109 includes the subject matter of Example 107 or 108, and optionally, wherein the WLAN measurement information comprises at least one Received Signal Strength Indication (RSSI) corresponding to signals communicated between the UE and the WLAN AP.

Example 110 includes the subject matter of any one of Examples 107-109, and optionally, wherein the request message and the response message comprise Long Term Evolution (LTE) Positioning Protocol A (LPPa) messages.

Example 111 includes the subject matter of any one of Examples 107-109, and optionally, wherein the request message and the response message comprise SLm Application Protocol (SLmAP) messages.

Example 112 includes the subject matter of any one of Examples 107-109, and optionally, wherein the network interface comprises an SLm interface configured to communicate with the eNB.

Example 113 includes the subject matter of any one of Examples 107-109, and optionally, wherein the network interface comprises a S1 interface configured to communicate with the eNB via a Mobility Management Entity (MME).

Example 114 includes the subject matter of any one of Examples 107-113, and optionally, wherein the location server comprises an Evolved Serving Mobile Location Centre (E-SMLC).

Example 115 includes the subject matter of any one of Examples 107-114, and optionally, wherein the location server comprises a Location Management Unit (LMU) to process a location of the UE based on the WLAN measurement information.

Example 116 includes a product comprising one or more tangible computer-readable storage media comprising computer-executable instructions operable to, when executed by at least one computer processor, enable the at least one computer processor to implement one or more operations at a location server, the operations comprising generating a request message addressed to an Evolved Node B (eNB) the request message comprising an identifier of a User Equipment (UE) and a request for Wireless Local Area Network (WLAN) measurements corresponding to the UE; sending the request message to the eNB; receiving a response message including WLAN measurement information, which is based at least on a range between the UE and at least one WLAN AP; and processing the WLAN measurement information.

Example 117 includes the subject matter of Example 116, and optionally, wherein the WLAN measurement information comprises at least one Fine Timing Measurement (FTM) between the UE and the WLAN AP.

Example 118 includes the subject matter of Example 116 or 117, and optionally, wherein the WLAN measurement information comprises at least one Received Signal Strength Indication (RSSI) corresponding to signals communicated between the UE and the WLAN AP.

Example 119 includes the subject matter of any one of Examples 116-118, and optionally, wherein the request message and the response message comprise Long Term Evolution (LTE) Positioning Protocol A (LPPa) messages.

Example 120 includes the subject matter of any one of Examples 116-118, and optionally, wherein the request message and the response message comprise SLm Application Protocol (SLmAP) messages.

Example 121 includes the subject matter of any one of Examples 116-118, and optionally, wherein the operations comprise communicating with the eNB via an SLm interface.

Example 122 includes the subject matter of any one of Examples 116-118, and optionally, wherein the operations comprise communicating with the eNB via a Mobility Management Entity (MME).

Example 123 includes the subject matter of any one of Examples 116-122, and optionally, wherein the location server comprises an Evolved Serving Mobile Location Centre (E-SMLC).

Example 124 includes the subject matter of any one of Examples 116-123, and optionally, wherein the operations comprise processing a location of the UE based on the WLAN measurement information.

Example 125 includes a method to be performed at a location server, the method comprising generating a request message addressed to an Evolved Node B (eNB) the request message comprising an identifier of a User Equipment (UE) and a request for Wireless Local Area Network (WLAN) measurements corresponding to the UE; sending the request message to the eNB; receiving a response message including WLAN measurement information, which is based at least on a range between the UE and at least one WLAN AP; and processing the WLAN measurement information.

Example 126 includes the subject matter of Example 125, and optionally, wherein the WLAN measurement information comprises at least one Fine Timing Measurement (FTM) between the UE and the WLAN AP.

Example 127 includes the subject matter of Example 125 or 126, and optionally, wherein the WLAN measurement information comprises at least one Received Signal Strength Indication (RSSI) corresponding to signals communicated between the UE and the WLAN AP.

Example 128 includes the subject matter of any one of Examples 125-127, and optionally, wherein the request message and the response message comprise Long Term Evolution (LTE) Positioning Protocol A (LPPa) messages.

Example 129 includes the subject matter of any one of Examples 125-127, and optionally, wherein the request message and the response message comprise SLm Application Protocol (SLmAP) messages.

Example 130 includes the subject matter of any one of Examples 125-127, and optionally, comprising communicating with the eNB via an SLm interface.

Example 131 includes the subject matter of any one of Examples 125-127, and optionally, comprising communicating with the eNB via a Mobility Management Entity (MME).

Example 132 includes the subject matter of any one of Examples 125-131, and optionally, wherein the location server comprises an Evolved Serving Mobile Location Centre (E-SMLC).

Example 133 includes the subject matter of any one of Examples 125-132, and optionally, comprising processing a location of the UE based on the WLAN measurement information.

Example 134 includes an apparatus of a location server, the apparatus comprising means for generating a request message addressed to an Evolved Node B (eNB) the request message comprising an identifier of a User Equipment (UE) and a request for Wireless Local Area Network (WLAN) measurements corresponding to the UE; means for sending the request message to the eNB; means for receiving a response message including WLAN measurement information, which is based at least on a range between the UE and at least one WLAN AP; and means for processing the WLAN measurement information.

Example 135 includes the subject matter of Example 134, and optionally, wherein the WLAN measurement information comprises at least one Fine Timing Measurement (FTM) between the UE and the WLAN AP.

Example 136 includes the subject matter of Example 134 or 135, and optionally, wherein the WLAN measurement information comprises at least one Received Signal Strength Indication (RSSI) corresponding to signals communicated between the UE and the WLAN AP.

Example 137 includes the subject matter of any one of Examples 134-136, and optionally, wherein the request message and the response message comprise Long Term Evolution (LTE) Positioning Protocol A (LPPa) messages.

Example 138 includes the subject miter of any one of Examples 134-136, and optionally, wherein the request message and the response message comprise SLm Application Protocol (SLmAP) messages.

Example 139 includes the subject matter of any one of Examples 134-136, and optionally, comprising means for communicating with the eNB via an SLm interface.

Example 140 includes the subject miter of any one of Examples 134-136, and optionally, comprising means for communicating with the eNB via a Mobility Management Entity (MME).

Example 141 includes the subject matter of any one of Examples 134-140, and optionally, wherein the location server comprises an Evolved Serving Mobile Location Centre (E-SMLC).

Example 142 includes the subject matter of any one of Examples 134-141, and optionally, comprising means for processing a location of the UE based on the WLAN measurement information.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

1.-25. (canceled)

26. An apparatus of an Evolved Node B (eNB), the apparatus comprising:
a network interface configured to receive a request message, the request message comprising a request from a location server for Wireless Local Area Network (WLAN) measurements corresponding to a User Equipment (UE); and
a location processing component configured to trigger the eNB to send a measurement request to at least one measurement provider selected from a group consisting of the UE and at least one WLAN Access Point (AP), the location processing component configured to receive from the at least one measurement provider WLAN measurement information, which is based at least on a range between the UE and the WLAN AP, the location processing component configured to trigger the eNB to send to the location server a response message including the WLAN measurement information.

27. The apparatus of claim 26, wherein the measurement provider comprises the UE.

28. The apparatus of claim 27, wherein the location processing component is configured to trigger the eNB to send to the UE a Radio Resource Control (RRC) message comprising the measurement request.

29. The apparatus of claim 26, wherein the measurement provider comprises the WLAN AP.

30. The apparatus of claim 26, wherein the WLAN measurement information comprises at least one Fine Timing Measurement (FTM) between the UE and the WLAN AP.

31. The apparatus of claim 26, wherein the WLAN measurement information comprises at least one Received Signal Strength Indication (RSSI) corresponding to signals communicated between the UE and the WLAN AP.

32. The apparatus of claim 26, wherein the request message and the response message comprise Long Term Evolution (LTE) Positioning Protocol A (LPPa) messages.

33. The apparatus of claim 26, wherein the request message and the response message comprise SLm Application Protocol (SLmAP) messages.

34. The apparatus of claim 26, wherein the network interface comprises an SLm interface configured to communicate with the location server.

35. The apparatus of claim 34, wherein the location processing component comprises a Location Management Unit (LMU) to process positioning of the UE based on the WLAN measurement information.

36. The apparatus of claim 26, wherein the network interface comprises an S1 interface configured to communicate with the location server via a Mobility Management Entity (MME).

37. The apparatus of claim 26, wherein the location server comprises an Evolved Serving Mobile Location Centre (E-SMLC).

38. The apparatus of claim 26 comprising one or more antennas, a memory and a processor.

39. A product comprising one or more tangible computer-readable non-transitory storage media comprising computer-executable instructions operable to, when executed by at least one computer processor, enable the at least one computer processor to implement one or more operations at an Evolved Node B (eNB), the operations comprising:
processing a request message comprising a request from a location server for Wireless Local Area Network (WLAN) measurements corresponding to a User Equipment (UE);
based on the request message, sending a measurement request to at least one measurement provider selected from a group consisting of the UE and at least one WLAN Access Point (AP);
receiving from the at least one measurement provider WLAN measurement information, which is based at least on a range between the UE and the WLAN AP; and
sending to the location server a response message including the WLAN measurement information.

40. The product of claim 39, wherein the measurement provider comprises the UE.

41. The product of claim 39, wherein the measurement provider comprises the WLAN AP.

42. The product of claim 39, wherein the WLAN measurement information comprises at least one Fine Timing Measurement (FTM) between the UE and the WLAN AP.

43. An apparatus of a location server, the apparatus comprising:
a location processor component configured to generate a request message addressed to an Evolved Node B (eNB), the request message comprising an identifier of a User Equipment (UE), and a request for Wireless Local Area Network (WLAN) measurements corresponding to the UE; and
a network interface configured to send the request message to the eNB, and to receive a response message including WLAN measurement information, which is based at least on a range between the UE and at least one WLAN AP, the location processor component configured to process the WLAN measurement information.

44. The apparatus of claim 43, wherein the WLAN measurement information comprises at least one Fine Timing Measurement (FTM) between the UE and the WLAN AP.

45. The apparatus of claim 43, wherein the request message and the response message comprise Long Term Evolution (LTE) Positioning Protocol A (LPPa) messages.

46. The apparatus of claim 43, wherein the request message and the response message comprise SLm Application Protocol (SLmAP) messages.

47. The apparatus of claim 43 comprising a Location Management Unit (LMU) to process a location of the UE based on the WLAN measurement information.

48. A product comprising one or more tangible computer-readable non-transitory storage media comprising computer-executable instructions operable to, when executed by at least one computer processor, enable the at least one computer processor to implement one or more operations at a location server, the operations comprising:
generating a request message addressed to an Evolved Node B (eNB) the request message comprising an identifier of a User Equipment (UE) and a request for Wireless Local Area Network (WLAN) measurements corresponding to the UE;
sending the request message to the eNB;
receiving a response message including WLAN measurement information, which is based at least on a range between the UE and at least one WLAN AP; and
processing the WLAN measurement information.

49. The product of claim 48, wherein the WLAN measurement information comprises at least one Fine Timing Measurement (FTM) between the UE and the WLAN AP.

50. The product of claim 48, wherein the operations comprise processing a location of the UE based on the WLAN measurement information.
